(19) United States
(12) Patent Application Publication
(10) Pub. No.: US 2014/0098745 A1
(43) Pub. Date: Apr. 10, 2014

(54) METHOD AND SYSTEM FOR COMPRESSING DATA PACKETS IN LTE EVOLVED MULTICAST BROADCAST MULTIMEDIA SERVICE

(71) Applicant: QUALCOMM INCORPORATED, San Diego, CA (US)

(72) Inventors: Srinivasan Balasubramanian, San Diego, CA (US); Kuo-Chun Lee, San Diego, CA (US); Jack Shyh-Hurng Shauh, San Diego, CA (US); Sivaramakrishna Veerepalli, San Diego, CA (US); Jun Wang, San Diego, CA (US)

(73) Assignee: QUALCOMM Incorporated, San Diego, CA (US)

(21) Appl. No.: 13/797,745

(22) Filed: Mar. 12, 2013

Related U.S. Application Data
(60) Provisional application No. 61/709,815, filed on Oct. 4, 2012.

(51) Int. Cl. H04W 72/00

(52) U.S. Cl. CPC H04W 72/005
USPC 370/328

(57) ABSTRACT

Compression of broadcast data packets is described in which a compressed broadcast data packet is formed by causing at least one field in a packet header to be excluded from the transmitted data packet. The data from the compressed or removed field is data that is otherwise available to a user entity. The user entity receives the compressed broadcast data packet and determines information corresponding to at least one of the eliminated fields in order to process the received broadcast information.

### RELATED MATERIAL

This application claims priority to U.S. Provisional Patent Application No. 61/709,815, filed Oct. 4, 2012 and entitled, “METHOD AND SYSTEM FOR COMPRESSING DATA PACKETS IN LTE EVOLVED MULTICAST BROADCAST MULTIMEDIA SERVICE,” the disclosure of which is incorporated herein in its entirety.

### BACKGROUND

1. Field

Aspects of the present disclosure relate generally to wireless communication systems, and more particularly, to efficient compression of data packets transmitted and/or received in an Evolved Multicast Broadcast Multimedia Service (eMBMS).

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs), also referred to as mobile entities. A UE may communicate with a base station via a downlink and an uplink. The downlink (or forward link) refers to the communication link from the base station to the UE, and the uplink (or reverse link) refers to the communication link from the UE to the base station. As used herein, a “base station” means an eNode B (eNB), a Node B, a Home Node B, or similar network component of a wireless communications system.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs. In unicast operation, each eNB is controlled so as to transmit signals carrying information directed to one or more particular subscriber UEs. The specificity of unicast signaling enables person-to-person services such as, for example, voice calling, text messaging, or video calling.

Recent LTE versions support eMBMS in the LTE air interface to provide the video streaming and file download broadcast delivery. For example, video streaming service is expected to be transported by the DASH (Dynamic Adaptive Streaming using HTTP) protocol over FLUTE (File Delivery over Unidirectional Transport) as defined in IETF RFC 3926 over UDP/IP packets. File download service is transported by FLUTE over UDP/IP protocols. Both high layers over IP are processed by the LTE broadcast channels in PHY and L2 (including MAC and RLC layers). However, such transport includes multiple inefficiencies which are not currently addressed in the communications industry.

### SUMMARY

In one aspect of the disclosure, a method operable by a network entity for wireless communication includes forming a compressed broadcast data packet by causing at least one field in a packet header of a broadcast data packet to be excluded, wherein the data of the at least one field is data that is otherwise available to a user entity, transmitting a notification to the user entity within a description message, the notification indicating that at least one compressed broadcast data packet will be transmitted, and transmitting the compressed broadcast data packet to the user entity.

In an additional aspect of the disclosure, an apparatus that includes means for forming a compressed broadcast data packet by causing at least one field in a packet header of a broadcast data packet to be excluded, wherein the data of the at least one field is data that is otherwise available to an end user entity, means for transmitting a notification to the user entity within a description message, the notification indicating that at least one compressed broadcast data packet will be transmitted, and means for transmitting the compressed broadcast data packet to the user entity.

In an additional aspect of the disclosure, an apparatus that includes at least one processor configured to: form a compressed broadcast data packet by causing at least one field in a packet header of a broadcast data packet to be excluded, wherein the data of said at least one field is data that is otherwise available to an end user entity; and transmit said compressed broadcast data packet to the user entity, transmit a notification to the user entity within a description message, the notification indicating that at least one compressed broadcast data packet will be transmitted, and a memory coupled to the at least one processor for storing the compressed broadcast data packet.

In an additional aspect of the disclosure, a computer program product includes a non-transitory computer-readable medium. The non-transitory computer readable medium includes code for causing a computer to form a compressed broadcast data packet by causing at least one field in a packet header of the compressed broadcast data packet to be excluded, wherein the data of the at least one field is data that is otherwise available to a user entity, transmit a notification to the user entity within a description message, the notification indicating that at least one compressed broadcast data packet will be transmitted, and transmit the compressed broadcast data packet to the user entity.

In an additional aspect of the disclosure, a method operable by a mobile entity for wireless communication that includes receiving a description message which includes a notification indicating that at least one compressed broadcast data packet will be transmitted to the mobile entity, receiving a compressed broadcast data packet via a wireless network, wherein the compressed broadcast data packet has been compressed prior to transmission in order to eliminate one or more fields from the packet header of the compressed broadcast data packet, and determining information corresponding to at least one of the eliminated fields.

In an additional aspect of the disclosure, an apparatus includes means for receiving a description message which includes a notification indicating that at least one compressed broadcast data packet will be transmitted to the mobile entity, means for receiving a compressed broadcast data packet via a wireless network, wherein the compressed broadcast data packet has been compressed prior to transmission in order to eliminate one or more fields from the packet header of the compressed broadcast data packet, and means for determining information corresponding to at least one of the eliminated fields.

In an additional aspect of the disclosure, an apparatus that includes at least one processor configured to receive a description message which includes a notification indicating that at least one compressed broadcast data packet will be transmitted to the mobile entity and a compressed broadcast data packet via a wireless network, wherein the compressed broadcast data packet has been compressed prior to transmission in order to eliminate one or more fields from the packet header of the compressed broadcast data packet and to determine information corresponding to at least one of the eliminated fields, and a memory coupled to the at least one processor for storing the compressed broadcast data packet.

In an additional aspect of the disclosure, a computer program product includes a non-transitory computer-readable medium. The non-transitory computer readable medium includes code for causing a computer to receive a description message which includes a notification indicating that at least one compressed broadcast data packet will be transmitted to the mobile entity, receive a compressed broadcast data packet via a wireless network, wherein the compressed broadcast data packet has been compressed prior to transmission in order to eliminate one or more fields from the packet header of the compressed broadcast data packet, and determine information corresponding to at least one of the eliminated fields.

The foregoing has outlined rather broadly the features and technical advantages of the present application in order that the detailed description that follows may be better understood. Additional features and advantages will be described hereinafter which form the subject of the claims. It should be appreciated by those skilled in the art that the conception and specific aspect disclosed may be readily utilized as a basis for modifying or designing other structures for carrying out the same purposes of the present application. It should also be realized by those skilled in the art that such equivalent constructions do not depart from the spirit and scope of the present application and the appended claims. The novel features which are believed to be characteristic of aspects, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present claims.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of a base station/eNB and a UE configured according to one aspect of the present disclosure.

FIG. 4 is a diagram of a signaling frame illustrating an example of symbol allocation for unicast and multicast signals.

FIG. 5 is a diagram illustrating MBMS over a Single Frequency Network (MBSFN) areas within an MBSFN service area.

FIG. 6 is a block diagram illustrating components of a wireless communication system for providing or supporting MBSFN service.

FIG. 7 is a block diagram illustrating a protocol stack of a LTE system.

FIG. 8 is a block diagram illustrating a protocol stack of an eMBMS system.

FIG. 9 is a block diagram illustrating a typical FLUTE over UDP over IPv4 packet format.

FIG. 10 is a block diagram illustrating a typical FLUTE over UDP over IPv6 packet format.

FIG. 11 is a block diagram illustrating a compressed FLUTE over UDP over IPv4 packet in accordance with an aspect of the present application.

FIG. 12 is a block diagram illustrating a compressed FLUTE over UDP over IPv6 packet in accordance with an aspect of the present application.

FIG. 13 is a block diagram illustrating a packet header compression for an IPv4 instance in accordance with one aspect of the present disclosure.

FIG. 14 is a block diagram illustrating a packet header compression for an IPv6 instance in accordance with one aspect of the present disclosure.

FIG. 15 is a block diagram illustrating an example broadcast network configured according to one aspect of the present disclosure.

FIG. 16 is a functional block diagram illustrating example blocks executed to implement one aspect of the present disclosure.

FIG. 17 is a functional block diagram illustrating example blocks executed to implement one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

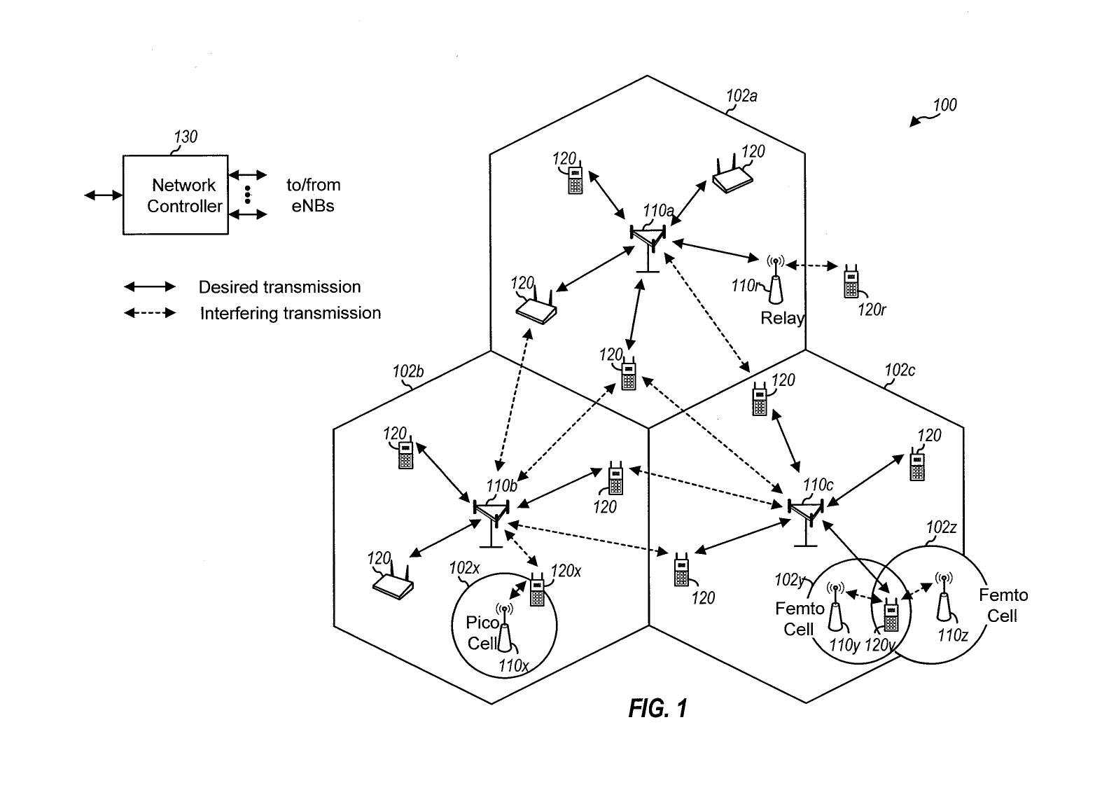

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HeNB). In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 5-40 Watts) whereas pico eNBs, femto eNBs and relays may have a lower transmit power level (e.g., 0.1-2 Watts).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a smartphone, a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. Additionally, a UE may include a processor and or other resources such as memory and the like which may be utilized to control and process communications coming to and leaving from the UE. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.4, 3, 5, 10 or 20 megahertz (MHz), respectively. The system bandwidth may also be partitioned into subbands. For example, a subband may cover 1.08 MHz, and there may be 1, 4, 7, 9 or 13 subbands for system bandwidth of 1.4, 3, 5, 10 or 20 MHz, respectively.

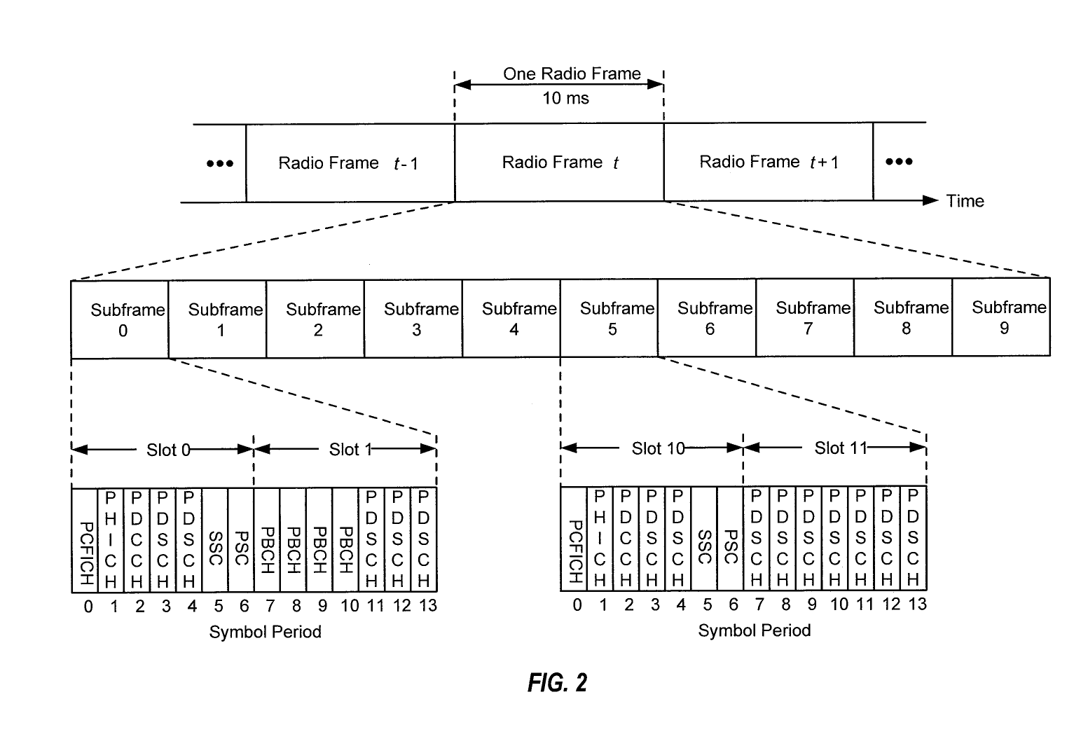

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may spread across frequency, in one or more configurable symbol periods. For example, the three REGs for the PHICH may all belong in symbol period 0 or may spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

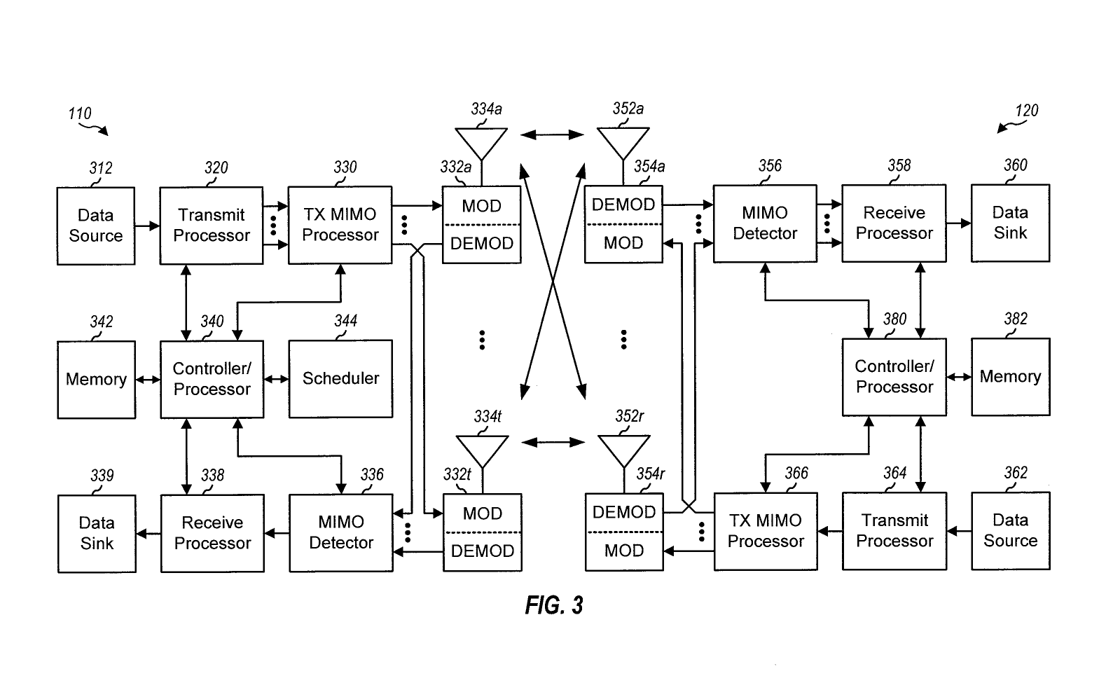

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

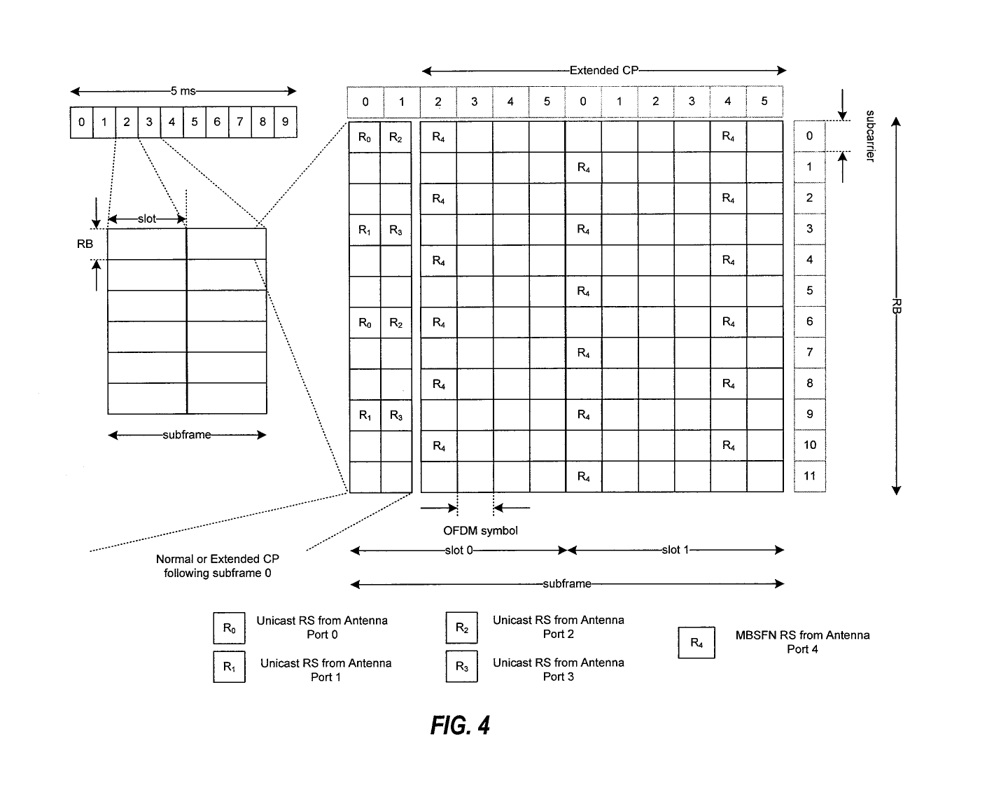

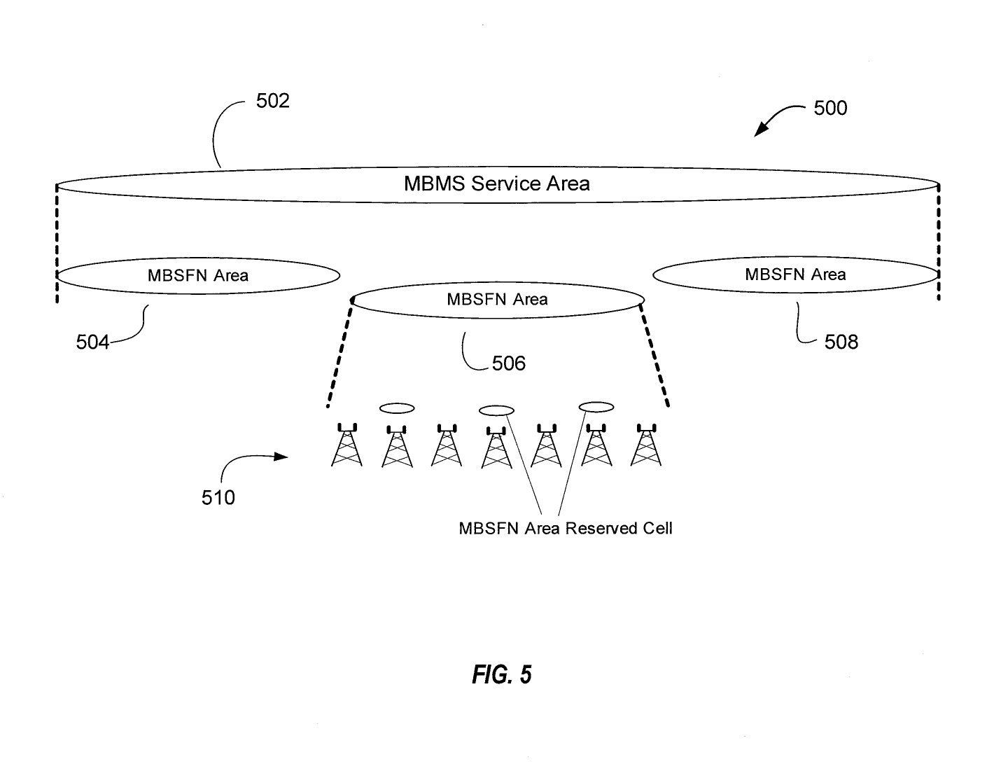

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### eMBMS AND UNICAST SIGNALING IN SINGLE FREQUENCY NETWORKS

One technique to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), can utilize such SFN operation. SFNs utilize radio transmitters, such as, for example, eNBs, to communicate with subscriber UEs. Groups of eNBs can transmit information in a synchronized manner, so that signals reinforce one another rather than interfere with each other. In the context of eMBMS, the shared content is transmitted from multiple eNBs of a LTE network to multiple UEs. Therefore, within a given eMBMS area, a UE may receive eMBMS signals from any eNB(s) within radio range as part of the eMBMS service area or MBSFN area. However, to decode the eMBMS signal each UE receives Multicast Control Channel (MCCH) information from a serving eNB over a non-eMBMS channel. MCCH information changes from time to time and notification of changes is provided through another non-eMBMS channel, the PDCCH. Therefore, to decode eMBMS signals within a particular eMBMS area, each UE is served MCCH and PDCCH signals by one of the eNBs in the area.

In accordance with aspects of the subject of this disclosure, there is provided a wireless network (e.g., a 3GPP network) having features relating to single carrier optimization for eMBMS. eMBMS provides an efficient way to transmit shared content from an LTE network to multiple mobile entities, such as, for example, UEs.

With respect to a physical layer (PHY) of eMBMS for LTE Frequency Division Duplex (FDD), the channel structure may comprise time division multiplexing (TDM) resource partitioning between eMBMS and unicast transmissions on mixed carriers, thereby allowing flexible and dynamic spectrum utilization. Currently, a subset of subframes (up to 60%), known as multimedia broadcast single frequency network (MBSFN) subframes, can be reserved for eMBMS transmission. As such current eMBMS design allows at most six out of ten subframes for eMBMS.

An example of subframe allocation for eMBMS is shown in FIG. 4, which shows an existing allocation of MBSFN reference signals on MBSFN subframes, for a single-carrier case. Components depicted in FIG. 4 correspond to those shown in FIG. 2, with FIG. 4 showing the individual subcarriers within each slot and resource block (RB). In 3GPP LTE, an RB spans 12 subcarriers over a slot duration of 0.5 ms, with each subcarrier having a bandwidth of 15 kHz together spanning 180 kHz per RB. Subframes may be allocated for unicast or eMBMS; for example in a sequence of subframes labeled 0, 1, 2, 3, 4, 5, 6, 7, 8, and 9, subframes 0, 4, 5, and 9 may be excluded from eMBMS in FDD. Also, subframes 0, 1, 5, and 6 may be excluded from eMBMS in time division duplex (TDD). More specifically, subframes 0, 4, 5, and 9 may be used for PSS/SSS/PBCH/paging/system information blocks (SIBs) and unicast service. Remaining subframes in the sequence, e.g., subframes 1, 2, 3, 6, 7, and 8 may be configured as eMBMS subframes.

With continued reference to FIG. 4, within each eMBMS subframe, the first 1 or 2 symbols may be used for unicast reference symbols (RSs) and control signaling. A CP length of the first 1 or 2 symbols may follow that of subframe 0. A transmission gap may occur between the first 1 or 2 symbols and the eMBMS symbols if the CP lengths are different. In related aspects, the overall eMBMS bandwidth utilization may be 42.5% considering RS overhead (e.g., 6 eMBMS subframes and 2 control symbols within each eMBMS subframe). Known techniques for providing MBSFN RSs and unicast RSs typically involve allocating the MBSFN RSs on MBSFN subframes (as shown in FIG. 4), and separately allocating unicast RSs on non-MBSFN subframes. More specifically, as FIG. 4 shows, the extended CP of the MBSFN subframe includes MBSFN RSs but not unicast RSs. The present technology is not limited to the particular frame allocation scheme illustrated by FIGS. 2 and 4, which are presented by way of example, and not by way of limitation. A multicast session or multicast broadcast as used herein may use any suitable frame allocation scheme.

### eMBMS SERVICE AREAS

FIG. 5 illustrates a system 500 including an MBMS service area 502 encompassing multiple MBSFN areas 504, 506, 508, which themselves include multiple cells or base stations 510. As used herein, an “MBMS service area” refers to a group of wireless transmission cells where a certain MBMS service is available. For example, a particular sports or other program may be broadcast by base stations within the MBMS service area at a particular time. The area where the particular program is broadcast defines the MBMS service area. The MBMS service area may be made up of one or more “MBSFN areas” as shown at 504, 506 and 508. As used herein, an MBSFN area refers to a group of cells (e.g., cells 510) currently broadcasting a particular program in a synchronized fashion using an MBSFN protocol. An “MBSFN synchronization area” refers to a group of cells that are interconnected and configured in a way such that they are capable of operating in a synchronized fashion to broadcast a particular program using an MBSFN protocol, regardless of whether or not they are currently doing so. Each eNB can belong to only one MBSFN synchronization area, on a given frequency layer. It is worth noting that an MBMS service area 502 may include one or more MBSFN synchronization areas (not shown). Conversely, an MBSFN synchronization area may include one or more MBSFN areas or MBMS service areas. Generally, an MBSFN area is made up of all, or a portion of, a single MBSFN synchronization area and is located within a single MBMS service area. Overlap between various MBSFN areas is supported, and a single eNB may belong to several different MBSFN areas. For example, up to 8 independent MCCHs may be configured in System Information Block (SIB) 13 to support services in different MBSFN areas. An MBSFN Area Reserved Cell or Base Station is a cell/base station within a MBSFN Area that does not contribute to the MBSFN transmission, for example a cell near a MBSFN Synchronization Area boundary, or a cell that that is not needed for MBSFN transmission because of its location.

### eMBMS SYSTEM COMPONENTS, FUNCTIONS AND PROTOCOL ARCHITECTURE

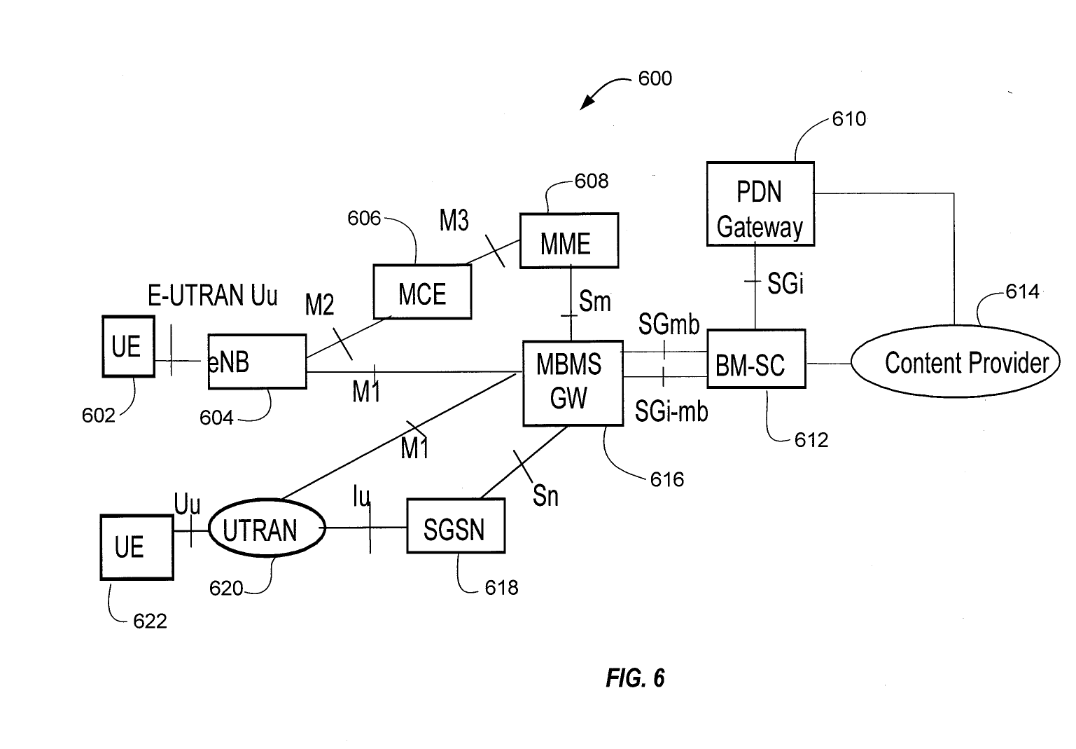

FIG. 6 illustrates functional entities of a wireless communication system 600 for providing or supporting MBSFN service. Such entities may include various hardware such as processors, memory, and communication input/output hardware as needed to accomplish aspects of the present application. Regarding Quality of Service (QoS), the system 600 uses a Guaranteed Bit Rate (GBR) type MBMS bearer, wherein the Maximum Bit Rate (MBR) equals the GBR. These components are shown and described by way of example, and do not limit the inventive concepts described herein, which may be adopted to other architectures and functional distributions for delivering and controlling multicast transmissions.

The system 600 may include an MBMS Gate Way (MBMS GW) 616. The MBMS GW 616 controls Internet Protocol (IP) multicast distribution of MBMS user plane data to eNodeBs 604 via an M1 interface; one eNB 604 of many possible eNBs is shown. In addition, the MBMS GW controls IP multicast distribution of MBMS user plane data to UTRAN Radio Network Controllers (RNCs) 620 via an M1 interface; one UTRAN RNC 620 of many possible RNCs is shown. The M1 interface is associated to MBMS data (user plane) and makes use of IP for delivery of data packets. The eNB 604 may provide MBMS content to a user equipment (UE)/mobile entity 602 via an E-UTRAN Uu interface. The RNC 620 may provide MBMS content to a UE mobile entity 622 via a Uu interface. The MBMS GW 616 may further perform MBMS Session Control Signaling, for example MBMS session start and session stop, via the Mobility Management Entity (MME) 608 and Sm interface. The MBMS GW 616 may further provide an interface for entities using MBMS bearers through the SG-mb (user plane) reference point, and provide an interface for entities using MBMS bearers through the SGi-mb (control plane) reference point. The SG-mb interface carries MBMS bearer service specific signaling. The SGi-mb interface is a user plane interface for MBMS data delivery. MBMS data delivery may be performed by IP unicast transmission, which may be a default mode, or by IP multicasting. The MBMS GW 616 may provide a control plane function for MBMS over UTRAN via a Serving General Packet Radio Service Support Node (SGSN) 618 and the Sn/Iu interfaces.

The system 600 may further include a Multicast Coordinating Entity (MCE) 606. The MCE 606 may perform an admission control function form MBMS content, and allocate time and frequency radio resources used by all eNBs in the MBSFN area for multi-cell MBMS transmissions using MBSFN operation. The MCE 606 may determine a radio configuration for an MBSFN Area, such as, for example, the modulation and coding scheme. The MCE 606 may schedule and control user plane transmission of MBMS content, and manage eMBMS service multiplexing, by determining which services are to be multiplexed in which Multicast Channel (MCH). The MCE 606 may participate in MBMS Session Control Signaling with the MME 608 through an M3 interface, and may provide a control plane interface M2 with the eNB 604.

The system 600 may further include a Broadcast-Multicast Service Center (BM-SC) 612 in communication with a content provider server 614. The BM-SC 612 may handle intake of multicast content from one or more sources such as the content provider 614, and provide other higher-level management functions as described below. These functions may include, for example, a membership function, including authorization and initiation of MBMS services for an identified UE. The BM-SC 612 may further perform MBMS session and transmission functions, scheduling of live broadcasts, and delivery, including MBMS and associated delivery functions. The BM-SC 612 may further provide service advertisement and description, such as advertising content available for multicast. A separate Evolved Packet System (EPS) bearer may be used to carry control messages between UE and BM-SC. The BM-SC may further provide security functions such as key management, manage charging of content providers according to parameters such as data volume and QoS, provide content synchronization for MBMS in UTRAN and in E-UTRAN for broadcast mode, and provide header compression for MBSFN data in E-UTRAN. The BM-SC 612 may indicate session start, update and stop to the MBMS-GW 616 including session attributes such as QoS and MBMS service area.

The system 600 may further include a Multicast Management Entity (MME) 608 in communication with the MCE 606 and MBMS-GW 608. The MME 600 may provide a control plane function for MBMS over E-UTRAN. In addition, the MME may provide the eNB 604, 620 with multicast related information defined by the MBMS-GW 616. An Sm interface between the MME 608 and the MBMS-GW 616 may be used to carry MBMS control signaling, for example, session start and stop signals.

The system 600 may further include a Packet Data Network (PDN) Gateway (GW) 610, sometimes abbreviated as a P-GW. The P-GW 610 may provide an Evolved Packet System (EPS) bearer between the UE 602 and BM-SC 612 for signaling and/or user data. As such, the P-GW may receive Uniform Resource Locator (URL) based requests originating from UEs in association with IP addresses assigned to the UEs. The BM-SC 612 may also be linked to one or more content providers via the P-GW 610, which may communicate with the BM-SC 612 via an IP interface.

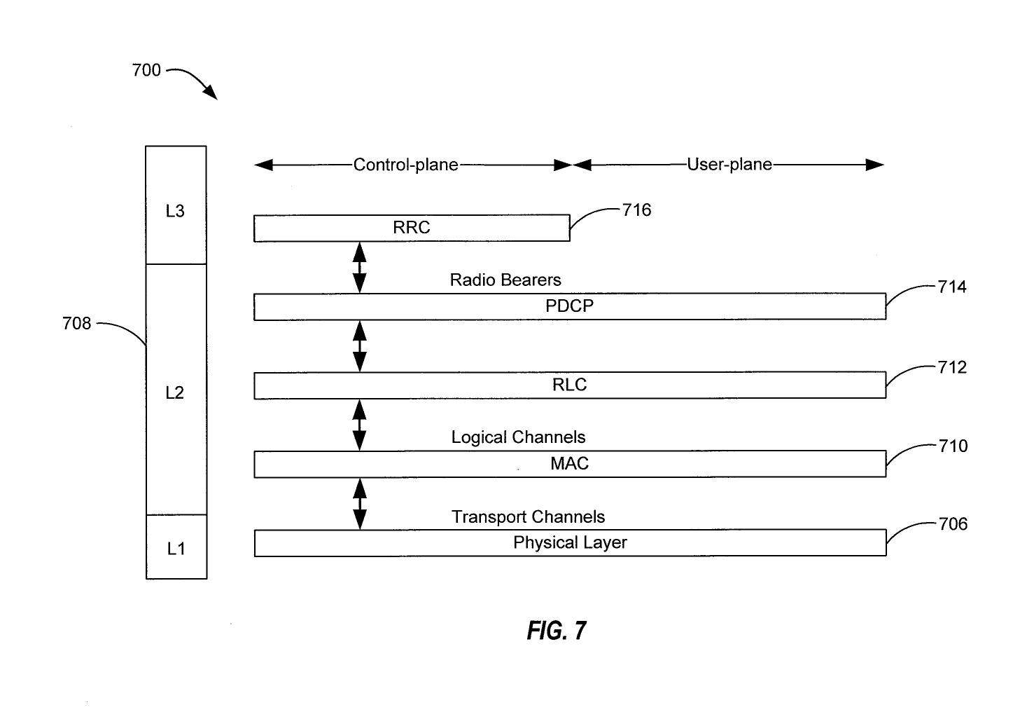

FIG. 7 is a diagram 700 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 706. Layer 2 (L2 layer) 708 is above the physical layer 706 and is responsible for the link between the UE and eNB over the physical layer 706.

In the user plane, the L2 layer 708 includes a media access control (MAC) sublayer 710, a radio link control (RLC) sublayer 712, and a packet data convergence protocol (PDCP) 714 sublayer, which are terminated at the eNB on the network side. Although not shown, the UE may have several upper layers above the L2 layer 708 including a network layer (e.g., IP layer) that is terminated at the PDN gateway 610 on the network side, and an application layer that is terminated at the other end of the connection (e.g., far end UE, server, etc.).

The PDCP sublayer 714 provides multiplexing between different radio bearers and logical channels. The PDCP sublayer 714 also provides header compression for upper layer data packets to reduce radio transmission overhead, security by ciphering the data packets, and handover support for UEs between eNBs. The RLC sublayer 712 provides segmentation and reassembly of upper layer data packets, retransmission of lost data packets, and reordering of data packets to compensate for out-of-order reception due to hybrid automatic repeat request (HARQ). The MAC sub layer 710 provides multiplexing between logical and transport channels. The MAC sub layer 710 is also responsible for allocating the various radio resources (e.g., resource blocks) in one cell among the UEs. The MAC sublayer 710 is also responsible for HARQ operations.

In the control plane, the radio protocol architecture for the UE and eNB is substantially the same for the physical layer 706 and the L2 layer 708 with the exception that there is no header compression function for the control plane. The control plane also includes a radio resource control (RRC) sublayer 716 in Layer 3 (L3 layer). The RRC sublayer 716 is responsible for obtaining radio resources (i.e., radio bearers) and for configuring the lower layers using RRC signaling between the eNB and the UE.

### eMBMS TRANSPORT PROTOCOLS AND ISSUES WITH PACKET HEADER EFFICIENCY

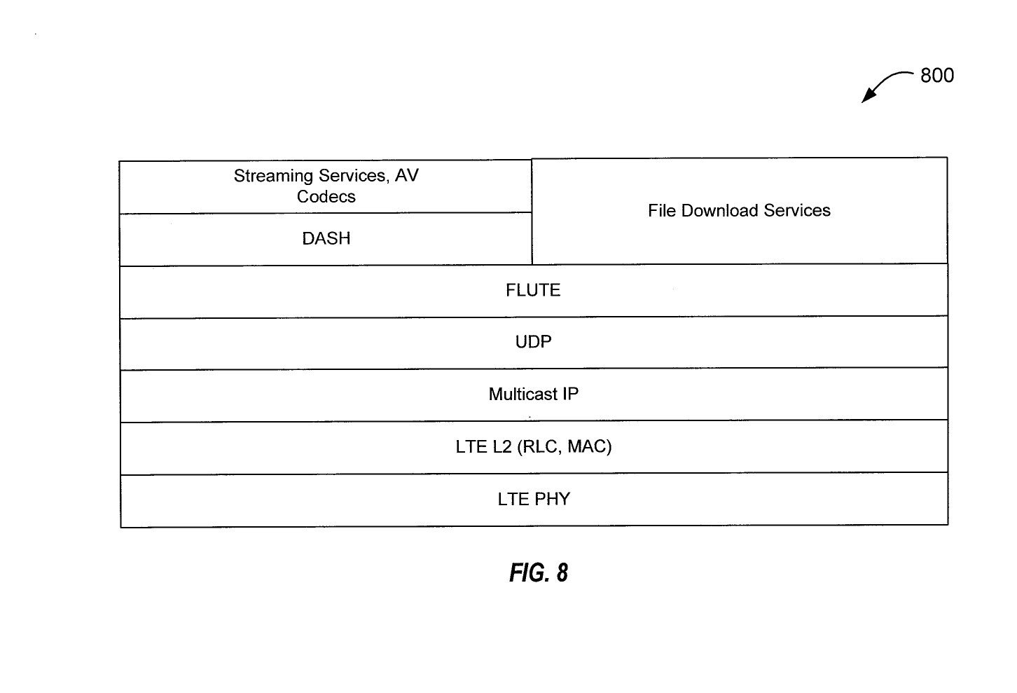

Recent LTE releases, e.g. release 9, support eMBMS in the LTE air interface to provide the video streaming and file download broadcast delivery. FIG. 8 illustrates a protocol stack 800 of an eMBMS system. As stated above, broadcast video streaming services may be transported by the DASH (Dynamic Adaptive Streaming using HTTP) protocol over FLUTE (File Delivery over Unidirectional Transport) as defined in IETF RFC 3926 over UDP/IP packets. File download services are typically transported by FLUTE over UDP/IP protocols. Both higher layers over IP are processed by the LTE broadcast channels in the physical (PHY) layer and layer 2 (L2) layers (including MAC and RLC layers).

For example, the video and/or audio media data may be accumulated for some time duration to form a DASH file segment, where the duration can be few seconds. Then, the FLUTE protocol fragments the file segment into multiple FLUTE packets. Each FLUTE packet is carried by one UDP/IP packet and sent to the UE over the LTE air interface.

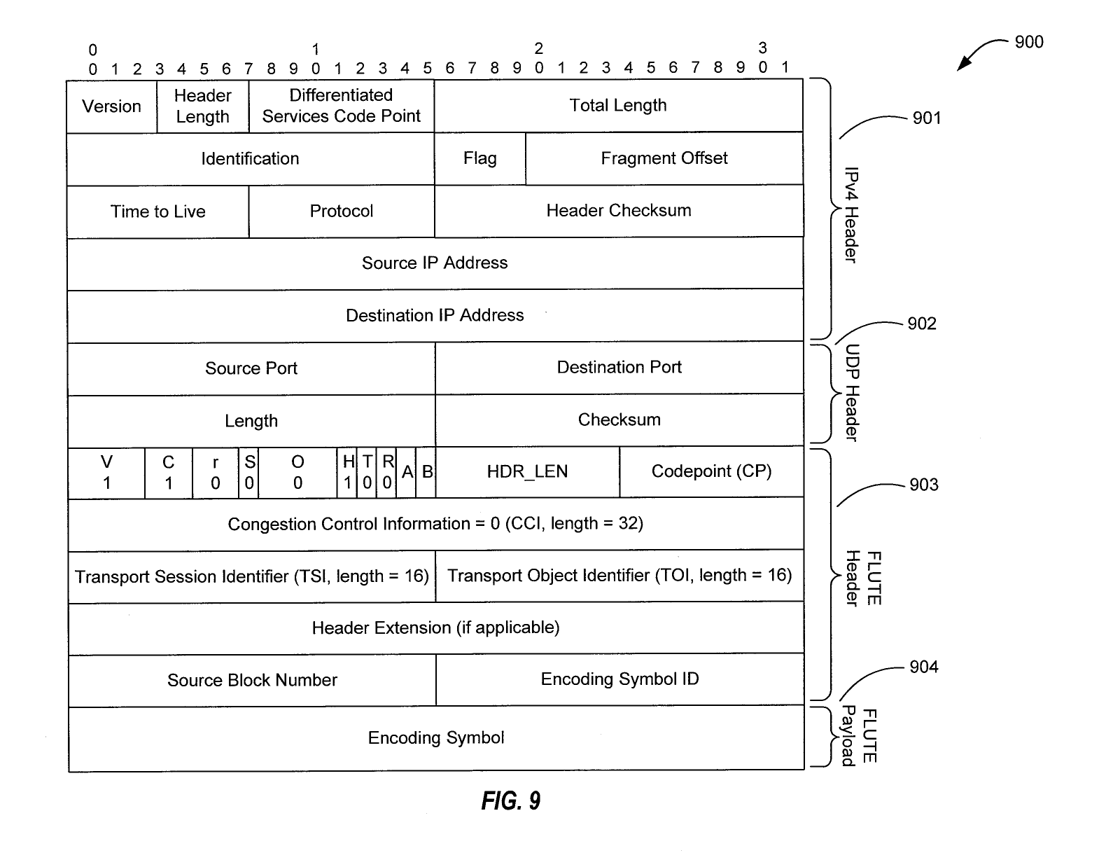

A typical FLUTE over UDP over IPv4 packet format 900 is illustrated in FIG. 9. Broadcast data packet 900 is divided into four sections, IPv4 header 901, UDP header 902, FLUTE header 903, and FLUTE payload 904. A total of 44 bytes are needed for all packet headers, excluding the FLUTE Header Extension. The FLUTE packet header 903 has the following fields:
Control flags (V, C, r, S, O, H, T, R, A, B): Version (V), Congestion control flag (C), reserved (r), TSI present flag (S), TOI present flag (O), Transport Session Size Variable (H), which may be used in defining the sizes of the Transport Session Identifier (TSI) and Transport Object Identifier (TOI), Sender Current Time present flag (T), Expected Residual Time presence flag (R), Close Session flag (A), Close Object flag (B) in which all flags, except A and B, are fixed in eMBMS.
LCT header length (HDR LEN)
Codepoint (CP) carrying FEC Encoding ID.
Congestion Control Information: Not used in the eMBMS download delivery per 3GPP TS 26.346 Section 7.1, so C=0 is expected to have (i.e. 4 bytes length), value CCI=0.
Transport Session Identifier (TSI): Identify the session of an IP address with length 32*S+16*H. In eMBMS, this field will normally have 16 bits (S=0, H=1).
Transport Object Identifier (TOI): Identify the file within a session with length 32*O+16*H. In eMBMS, TOI should have 16 bits (O=0, H=1).
Header Extension (if applicable), e.g. EXT_CENC, EXT_FDT, EXT_FTI. The length can be determined by HDR_LEN, i.e. HDR_LEN minus the length of preceding header fields. In eMBMS, this field will normally be a multiple of 32 bits in length.
Source Block Number and Encoding Symbol ID. For example, a 1 MB file may be fragmented into 10 source blocks, each with 100 source symbols (each symbol with 1 Kbytes). FEC may add additional redundancy of 20 symbols in each source block. Each of these symbols may be put in a UDP/IP packet. Therefore, in this example there would be 1200 FLUTE/UDP/IP packets with source block number=0˜9 and encoding symbol ID=0˜119 to indicate the encoded data in the file.

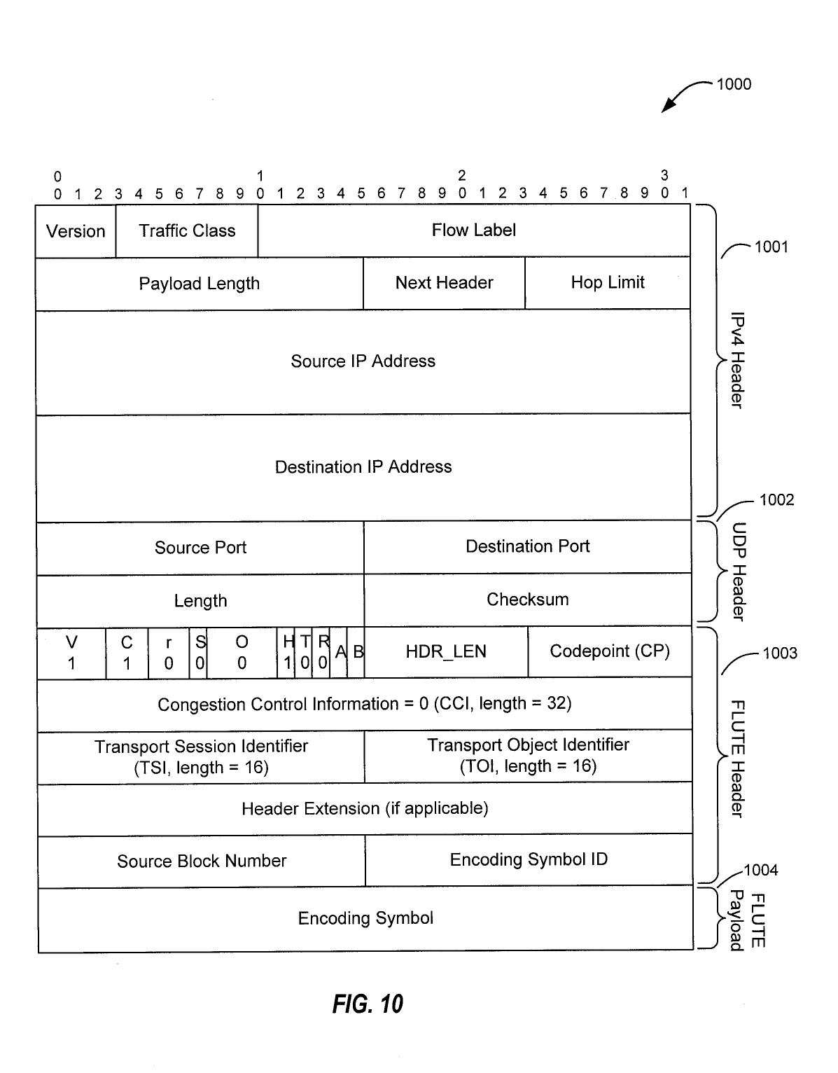

FIG. 10 illustrates a typical FLUTE over UDP over IPv6 packet format 1000. Broadcast data packet 1000 is divided into four sections, IPv6 header 1001, UDP header 1002, FLUTE header 1003, and FLUTE payload 1004. A total of 64 bytes are needed for all packet headers, excluding the FLUTE Header Extension. The additional bytes over the IPv4 packet stems from the larger source and destination address fields, which are each 16 bytes, in IPv6 header 1001.

To receive eMBMS data, the UE completes a service announcement procedure in which a USD is obtained that provides relevant information with regard to the broadcast service and protocol configuration to the UE, such as:
Sender IP address
The number of channels in the session
Destination IP address and port number for each channel in the session per media
Transport Session Identifier (TSI) of the session
Start time and end time of the session
Protocol ID (i.e. FLUTE/UDP)
Media type(s) and fmt-list
Data rate using existing SDP bandwidth modifiers
Mode of MBMS bearer per media
Forward Error Correction (FEC) capabilities and related parameters, e.g. FEC-Encoding-ID
Temporary Mobile Group Identity (TMGI)
   This information, when included in an uncompressed FLUTE/UDP/IP broadcast packet header may utilize a significant amount of space in a packet, e.g. in the examples below knowledge of one or more of these is utilized to preserve 19 bytes in an IPv4 and 42 bytes in an IPv6 transmission.

It should be noted that the information provided in the USD may represent the same or similar information as would be found in the standard FLUTE/UDP/IP header. However, the information may be found in a different format in the USD than typically used in the header. For example, the IP address may be presented in a text format in the USD, while the same IP address will be expressed in as a bit stream in a standard FLUTE/UDP/IP header. When the UE desires to decompress the header information, it would use the text format of the IP address from the USD and convert it to the bit stream format for processing the broadcast packet.

Accordingly, the FLUTE/UDP/IP broadcast packet header, such as in broadcast data packets 900 and 1000, may provide duplicative information and, therefore, create unnecessary overhead in data transmission. Aspects of the present application provide solutions to reduce packet header overhead in eMBMS.

### INFORMATION FIELDS TO POTENTIALLY COMPRESS

It is appreciated that a FLUTE/UDP/IP broadcast packet header includes information which is static, having limited variance, and/or has predictable variation. Therefore, certain portions of a FLUTE/UDP/IP broadcast packet header lend themselves to be compressed by removing that information or those data fields from the broadcast packet header. For example, packet header fields with potential for compression include static fields that are known from the USD such as: Version (IPv4 & IPv6), Source IP Address, Destination IP Address (IPv4 & IPv6), Destination UDP Port (UDP), Protocol=17 (IPv4), Next Header=17 (IPv6), Header Length=5 (IPv4), Congestion Control Information=0 (FLUTE), Transport Session Id (FLUTE), and 14 leading bits in Control Flags (FLUTE). Static fields unknown from the USD may also be compressed such as the Source UDP Port (UDP).

Additionally, some fields may be variable, but may still be candidates for compression. For example, a FLUTE/UDP/IP broadcast packet header may include fields that are variable but predictable such as: Total Length, Header Checksum (IPv4), Payload Length (IPv6), and Length, Checksum (UDP). Further, a packet header may include fields that are variable but have limited variation such as: DSCP, Time to Live (IPv4), Traffic Class, Flow Label, Hop Limit (IPv6), and Codepoint (FLUTE).

### EXAMPLE COMPRESSION ALGORITHM

As noted above, the USD provides certain static fields to a UE prior to when a FLUTE/UDP/IP broadcast data packet is received at the UE. Specifically, in some aspects the UE already has information relating to the following fields: Version (IPv4 & IPv6) that can be derived from IP address, Source IP Address, Destination IP Address (IPv4 & IPv6), Destination UDP Port (UDP), Protocol=17 (IPv4), Next Header=17 (IPv6), Header Length=5 (IPv4), Congestion Control Information=0 is well known (FLUTE), Transport Session ID (FLUTE), and 14 leading bits in Control Flags are well known in eMBMS (FLUTE). In order to compress the FLUTE packet, such as broadcast data packets 900 and 1000, the network removes those static and known header fields, derivable from USD fields, from the actual broadcast data packet transmission. In various aspects of the present disclosure, the UE knows which fields have been compressed in a compressed broadcast header, and, therefore, would know which information from the USD or other description messages it would use to decompress the compressed data packets. Therefore, the UE may use the description message to derive or retrieve the missing values when needed.

It should be noted that various means may be used to inform the UE that compression has taken place. In one aspect, to enable such a compression, the network may signal a compression flag in a description message, such as the USD or FDT. For example, a compression flag may comprise a character string field of “yes” or “no” or a “1” or “0” flag to show whether compression will be performed by the network. As the UE receives the USD and identifies the compression flag, the UE will know whether any received broadcast packets will be compressed. The UE will then know to use the information from the USD to decompress or recover the compressed header data. In another aspect, information may be included in a File Delivery Table (FDT) to notify the UE that compression has taken place in a received data packet. An FDT may also include information regarding which data has been compressed (e.g. static fields and/or fields with limited variance) and may include rules or protocol regarding how to decompress the compressed data. It is noted that when a compression flag is included, the USD will generally include the specific information regarding what fields are compressed along with the uncompressed values so that a UE may have information on how to decompress a packet. It is further noted that in some aspects, one or more fields, such as length or checksum, can be derived from other fields and, therefore, may be compressed, yet not included in the USD.

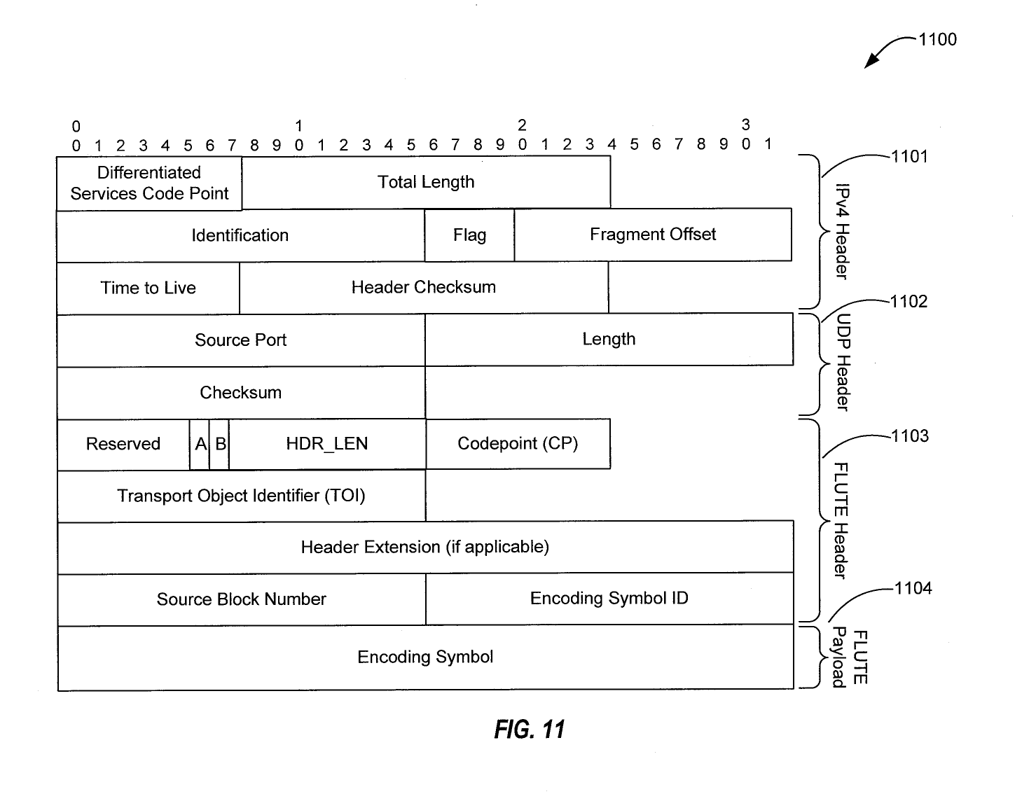

FIG. 11 illustrates a compressed FLUTE over UDP over IPv4 packet 1100 in accordance with an aspect of the present application. As can be seen, IPv4 header 1101, UDP header 1102, and FLUTE header 1103 have been compressed to remove certain header information. Specifically, the Version, Header Length, Differentiated Services Code Point, Protocol, Source IP Address and Destination IP address fields have been removed from IPv4 header. The Destination Port field has been removed from the UDP header. Moreover, all control fields except A and B and the CCI and TSI fields have been removed from the FLUTE header. As a result of this compression, packet 1100 has been reduced to utilizing 25 bytes (not including the optional header extension). This particular compression results in a 57% header size reduction. Such a compression provides a significant reduction in overhead compared to current transmission methods.

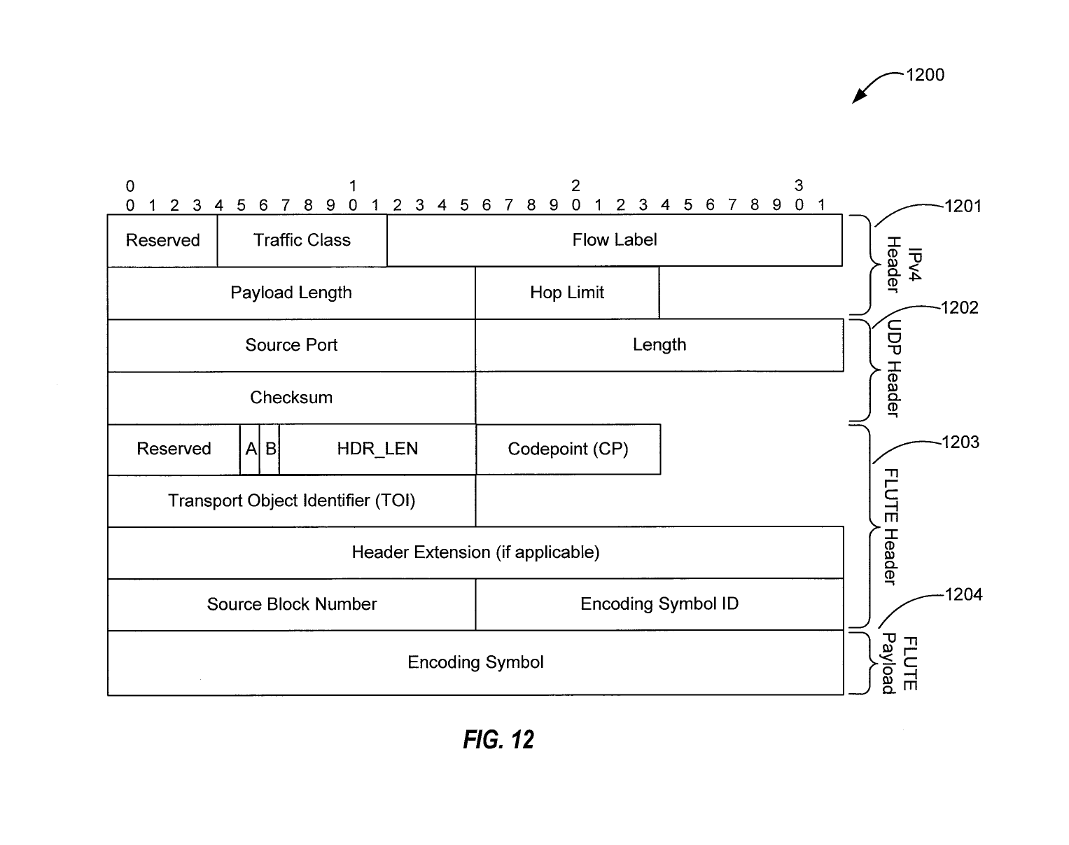

FIG. 12 illustrates a compressed FLUTE over UDP over IPv6 packet 1200 in accordance with an aspect of the present application. As with the IPv4 case, IPv6 header 1201, UDP header 1202, and FLUTE header 1203 have been compressed in this example case to remove the certain static fields known from the USD. Specifically, the Version, Next Header, Source IP Address and Destination IP address fields have been removed from IPv4 header. The Destination Port field has been removed from the UDP header. Moreover, all control fields except A and B and the CCI and TSI fields have been removed from the FLUTE header. As a result of this compression, packet 1200 has been reduced to 22 bytes (not including the optional header extension). This particular compression in an instance using IPv6, results in a 34% header size reduction.

It is noted that the above solutions assume that, if there are multiple UDP/IP sessions per TMGI, then the Source Port would normally be different for different UDP/IP sessions, provided that no IPv4 packet fragmentation is used. If IPv4 packet fragmentation is used, aspects may only allow one UDP/IP session per TMGI. In such an event, other compression algorithms may be utilized to reduce packet overhead.

### SECOND EXAMPLE COMPRESSION ALGORITHM

In another aspect, multiple types of fields may be compressed, such as fields that are not changed on a frequent basis and/or fields which may be derived and regenerated.

In one example, a context ID is signaled along with the uncompressed packet header value in the USD as a part of the service announcement procedure. With this context ID, a UE may, as described below, utilize the provided mapping information to decompress (or associate) compressed fields, in the event that there are multiple UDP/IP connections sharing one MBMS traffic channel (MTCH) or TMGI.

In general, a session context may be defined by a combination of information that identifies the source and destination of the packet. For example, a session context may be defined by the combination of the IP source and destination addresses, the UDP source and destination ports, and some FLUTE identifier, such as the source block number, encoding symbol ID, and the like. The communicating network entities may use various hash functions on these fields to index a table of stored session contexts. Thus, the transmitting and receiving entities would have such a stored session context table. The context ID indicates the session context to which that packet belongs. Because the context ID is signaled in the USD, a UE, receiving the compressed broadcast data packet with an associated context ID, may be able to determine which UDP/IP session context the data packet belongs when multiple UDP/IP connections share the same MTCH or TMGI by using the context ID to index a stored session of session contexts.

To restore the uncompressed packet header by the UE in one aspect of the disclosure, the context ID provided in one or more of a USD or an FDT may be used by the UE to map the session context associated with the compressed broadcast packet to the USD or FDT corresponding to the same session context. Using the available information from the corresponding USD or FDT, the UE may recover the compressed data, such as length, checksum, and the like, in order to get any of the packet header information the UE may use for additional processing.

It should be noted that the context ID may be implemented in a number of different ways, e.g., in one aspect, the context ID may be a 6-bit ID, the context ID may also be smaller or larger than 6-bits in other aspects, etc. Any format that allows information to be sent to the UE in order to notify the UE that a packet has been compressed and the UE can look up or derive the compressed information may be utilized.

It should further be noted that additional mechanisms for identifying the particular session context based on the context ID may be used by additional aspects of the present disclosure. The various aspect of the present disclosure are not limited to any single process to differentiate multiple UDP/IP connections or sessions.

It should further be noted that, in order to keep the length of the FLUTE header in an integral number of octets, the context ID may be configured to precede the A and B fields in the FLUTE header part. Alternatively, the context ID preceding A and B fields may be included in the first octet of the header-compressed FLUTE/UDP/IP packet. Various aspects of the present disclosure may use many different implementations in order to accommodate the context ID.

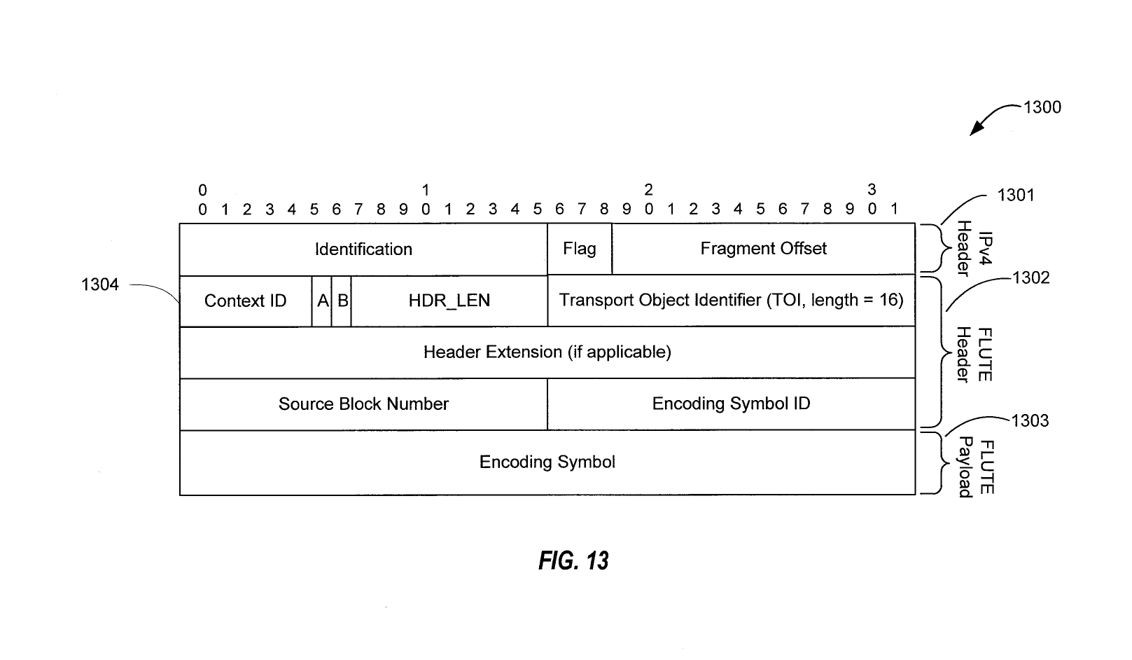

A compressed broadcast data packet header 1300 for an IPv4 broadcast data packet in accordance with this aspect is illustrated in FIG. 13. As can be seen, broadcast data packet 1300 includes an IPv4 header 1301, FLUTE header 1302 and FLUTE payload 1303, but does not include a UDP header portion. Additionally, context ID 1304 has been added at the beginning of the FLUTE header 1302. As a result, when utilizing the inventive compression described herein, broadcast data packet 1300 has been compressed to 12 bytes (excluding the header extension). It is noted that in the event that there is no fragmentation in an IPv4 transmission, an IP header can be further compressed (not shown in a figure) to where even fewer bytes are remaining.

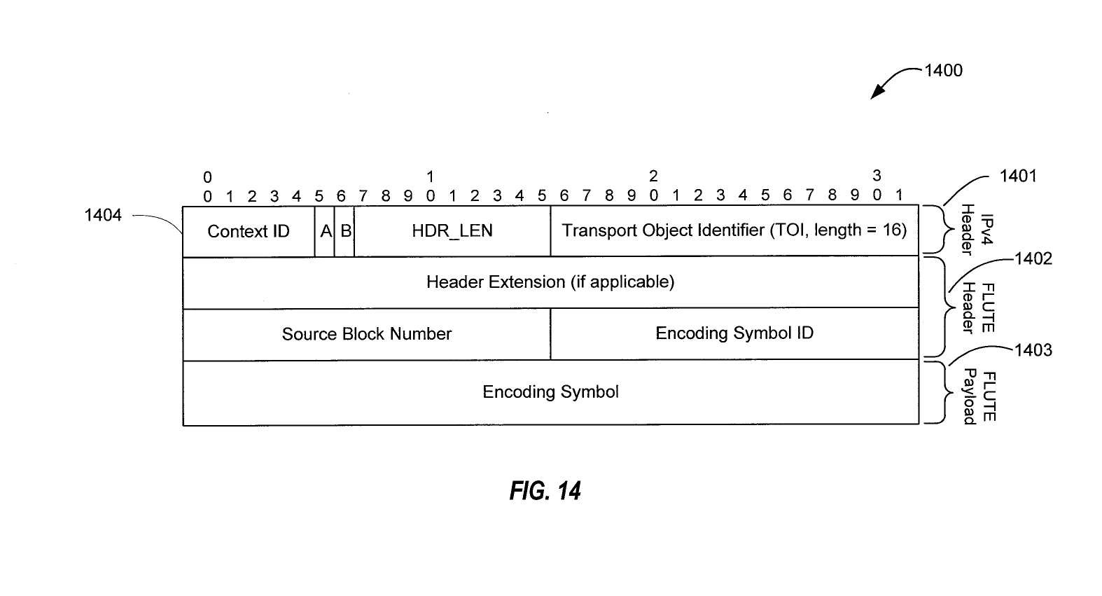

FIG. 14 illustrates a compressed broadcast packet header 1400 for an IPv6 broadcast data packet in accordance with this aspect. As can be seen, broadcast data packet 1400 includes an IPv6 header 1401, which in this example includes no fields. In some cases, IPv6 header 1401 may include a Next Header field. Broadcast data packet 1400 further includes FLUTE header 1402 and FLUTE payload 1403, but does not include a UDP header portion. Additionally, context ID 1404 has been added at the beginning of the FLUTE header 1402. As a result, when utilizing the inventive compression in this example, broadcast data packet 1400 has been significantly compressed.

### EXAMPLE COMPRESSION FORMAT

One example of compression information signaled in the USD can be coded as illustrated in the following example code block:
“a=header-compression” SP “no”/“yes” [SP “ipv4”/“ipv6” CRLF compression-list]
compression-list=1*(ip-compression “;” CRLF)
ip-compression=(context-id SP version SP dscp SP ttl SP protocol SP
src-ip SP dest-ip SP src-port SP dest-port SP codepoint SP tsi)/(context-id SP version SP traffic-class SP flow-label SP next-header SP hop-limit
SP src-ip SP dest-ip SP src-port SP dest-port SP codepoint SP tsi)

Where CRLF represents a carriage return line feed, SP represents a space, the format “1*” represents 1 or more repetitions, the format “a/b” represents either a or b, expressions with a set of parentheses “( )” represent one atomic expression, and elements noted within quotation marks “ ” represent characters.

It should be noted that Congestion Control Information=0 and the 14 leading bits in Control Flags of a packet header, such as FLUTE packet header 903, are well known in LTE eMBMS. Therefore, compression information does not need to include these bits.

In an example USD file, the data may appear as follows:
a=header-compression yes ipv4
0 4 0 1 17 168.212.226.1 224.0.0.1 10000 10000 0 0;
1 4 0 1 17 168.212.226.1 224.0.0.1 10000 10000 0 1;

In the above example compression format, IPv4 is applied with two variations with two TSI values 0, 1 for two FLUTE sessions in one eMBMS channel. The above compression format will yield results such as the ones illustrated in FIGS. 13-14.

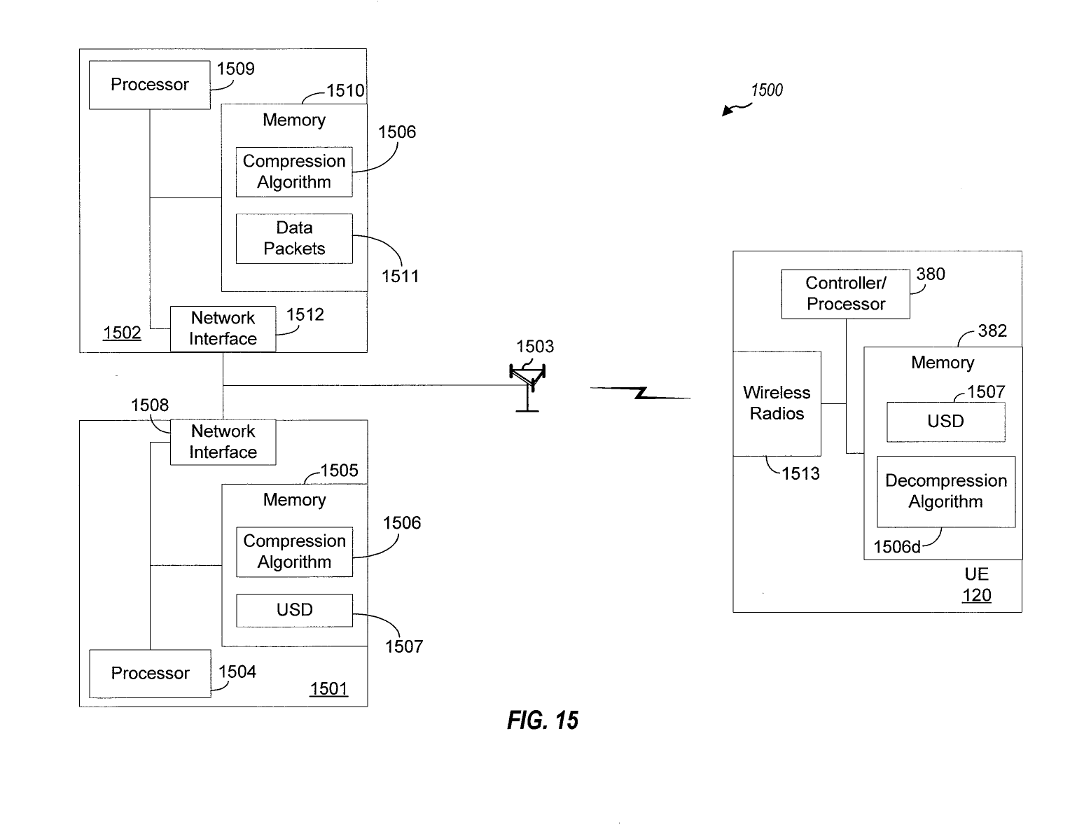

FIG. 15 is a block diagram illustrating an example broadcast network 1500 configured according to one aspect of the present disclosure. Broadcast network 1500 includes broadcast network entities, such as network entity 1501 and 1502. Network entities 1501 and 1502 may comprises one or more or a combination of one or more of the network entities illustrated in FIG. 6, including content provider 614, BM-SC 612, MBMS GW 616, and the like. In operation, network entities 1501 and 1502 may also comprise the same network entity. For purposes of illustration, network entities 1501 and 1502 are shown to be separate network entities of broadcast network 1500. UE 120 may access broadcast network through eNB 1503. Under control of controller/processor 380, wireless radios 1513 establish radio communication with eNB 1503 and, thereafter, communication with one or more of network entities 1501 and 1502 through eNB 1503.

In order to access a desired broadcast service offered by broadcast network 1500, UE 120 establishes communication with network entity 1501 to obtain USD file 1507. Network entity 1501 maintains USD file 1507 in memory 1505. Under control of processor 1504, network entity 1501 communicates with eNB 1503, through network interface 1508, to transmit USD file 1507 to UE 120. Under control of controller/processor 380, UE 120 receives USD file 1507 from eNB 1503 through wireless radios 1513 and stores USD file 1507 in memory 382. USD file 1507 provides information to UE 120 for accessing the broadcast service.

According to an aspect of the present disclosure, network entity 1501, under control of processor 1504, executes compression algorithm 1506 before transmitting USD file 1507. Broadcast network 1500 implements a compression system configured according to one aspect of the present disclosure. As such, when executing compression algorithm 1506, network entity 1501 inserts a compression indicator, such as a compression flag or the like, into USD file 1507. Thus, when UE 120 receives USD file 1507, it reads the compression flag and knows that any broadcast data packets received that are associated with this service will be compressed.

When the broadcast service session starts, network entity 1502, under control of processor 1509, packages data packets 1511, stored in memory 1510, into compressed broadcast data packet. Executing compression algorithm 1506, processor 1509 removes predetermined header fields representing information that may be obtainable or derivable from the information contained in USD 1507. The combination of these components and acts of network entity 1502 may provide means for forming a compressed broadcast data packet wherein the compressed broadcast data packet is compressed by causing at least one field in a packet header of the compressed broadcast data packet to be excluded from the compressed broadcast data packet, wherein the data of the at least one field is data that is otherwise available to a user entity. Network entity 1502 may also include a means for transmitting a notification to the user entity within a USD message, the notification indicating that at least one compressed broadcast data packet will be transmitted.

Network entity 1502 then transmits the compressed broadcast data packets onto broadcast network 1500 through network interface 1512 and are communicated by eNB 1503. The combination of these components and acts may provide means for transmitting the compressed broadcast data packet to the user entity.

It should be noted that, prior to transmission of the compressed broadcast data packets by network entity 1502, network entity 1502 may transmit a notification to UE 120 through eNB 1503 which indicates to UE 120 that broadcast data packets to the desired service are being transmitted.

UE 120, under control of controller/processor 380, tunes wireless radios 1513 to the appropriate frequencies and time for receiving the compressed broadcast data packets of the desired broadcast service. UE 120 may tune wireless radios 1513 to receive the broadcast packets in response to a previous notification received from network entity 1502. Alternatively, USD file 1507 may indicate when UE 120 should access broadcast network 1500 to receive the broadcast packets. The combination of these components and acts may provide means for receiving a USD message which includes a notification indicating that at least one compressed broadcast data packet will be transmitted to the mobile entity and means for receiving a compressed broadcast data packet via a wireless network, wherein the compressed broadcast data packet has been compressed prior to transmission in order to eliminate one or more fields from the packet header of the compressed broadcast data packet.

UE 120, having identified the compression flag of USD file 1507, knows that the received compressed broadcast data packets do not contain all of the standard header fields and information. Accordingly, under control of controller/processor 380, UE 120 executes decompression algorithm 1506d stored in memory 382. Execution of decompression algorithm 1506d provides functionality that accesses USD file 1507 to retrieve the information contained therein, that UE 120 may use to reconstruct the compressed header data. For example, as previously noted, processor 380, executing decompression algorithm 1506d may access the text-based IP address identified in USD file 1507, convert it to the bit stream format and use the bit stream format to perform further processing of the broadcast data. The combination of these components and acts may provide means for determining information corresponding to at least one of the eliminated fields.

In view of exemplary systems shown and described herein, methodologies that may be implemented in accordance with the disclosed subject matter, will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

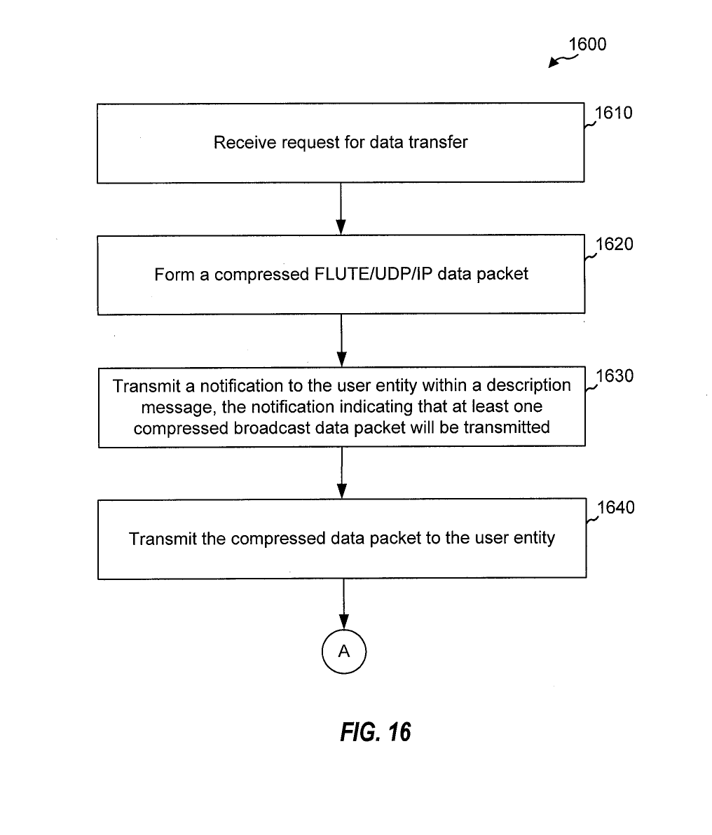

In accordance with one or more aspects of the aspects described herein, with reference to FIG. 16, there is shown a methodology 1600, operable by a network device for facilitating a data transfer session using compressed data packets. Specifically, method 1600 may involve, at 1610, receiving a request for a data transfer session or identifying data intended for a broadcast or multicast service. Such broadcast sessions may include streaming live audio, video, and or any other data which can utilize protocols set forth in method 1600. Method 1600 may involve, at 1620, forming a compressed broadcast data packet. The compressed broadcast data packet may be compressed by causing at least one field in a packet header of the broadcast data packet to be excluded from the transmitted packet. With reference to FIG. 15, for example, network entity 1502 may execute compression algorithm 1506 by processor 1509 in order to create the compressed header for data packets 1511. Additionally, the data which is excluded may be otherwise available to a user entity. This availability may come from a previous reception of the data or may be available due to the end user entity's abilities to derive the data. Method 1600 may also include, at 1630, transmitting a notification to the user entity within a description message, the notification indicating that at least one compressed broadcast data packet will be transmitted; Method 1600 may also involve, at 1640, transmitting the compressed data packet to the user entity, with network entity 1502 transmitting the compressed broadcast data packets onto broadcast network 1500 to eNB 1503 through network interface 1512.

In related aspects fields that may be excluded may include at least one static field and the data from the at least one static field may be available to the user entity as a result of a previously transmitted description message, such as USD file 1507 or an FDT, stored in memory 1505 of network entity 1501, which is transmitted to UE 120 when UE 120 establishes accessibility to the broadcast services. In a further aspect, fields that may be excluded may include at least one variable field. Such fields may include data that is derivable by the user entity. Alternatively, such fields may be utilized due to their variation being limited in nature.

In further related aspects, method 1600 may include transmitting a notification by the network entity, such as network entity 1502, to a user entity, such as UE 120, which notifies the user entity that there is at least one compressed broadcast data packet which is being transmitted. This notification may be sent prior to a packet transmission in a stand-alone message or as part of other communication procedures. Additionally, a notification may be included as a field in the compressed broadcast data packet itself, such as an FDT.

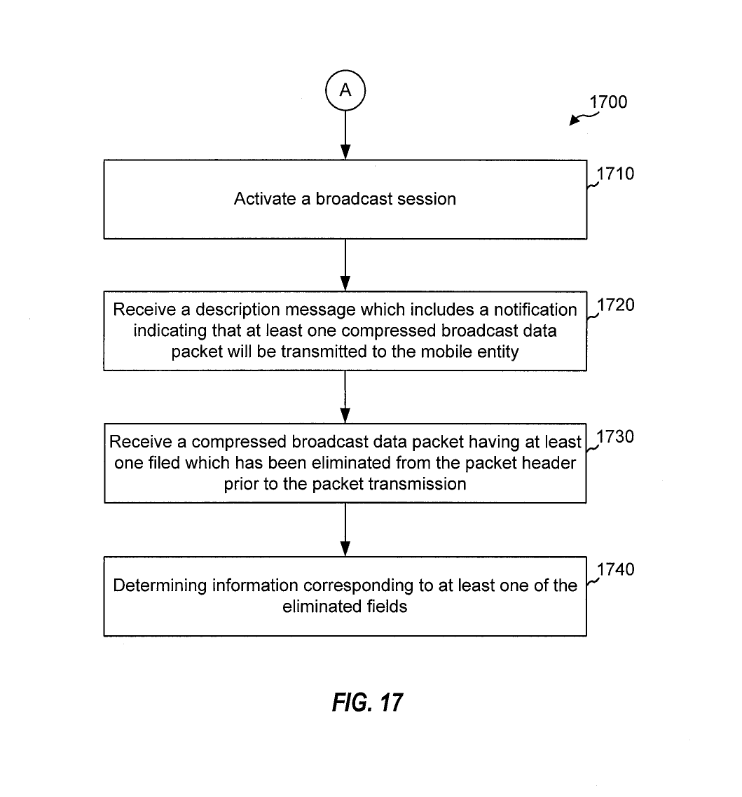

In accordance with one or more aspects of the aspects described herein, with reference to FIG. 17, there is shown a methodology 1700, operable by a user device, such as a mobile device and the like, for receiving a broadcast data session using compressed broadcast data packets. Specifically, method 1700 may involve, at 1710, activating a broadcast session. Such a session may be initiated either by the user device or a remote resource. Method 1700 may further involve, at 1720, receiving a description message which includes a notification indicating that at least one compressed broadcast data packet will be transmitted to the mobile entity. Method 1700 may also include, at 1730, receiving a compressed broadcast data packet having at least one field which has been eliminated from the packet header prior to the packet transmission. With reference to FIG. 15, UE 120, under control of controller/processor 380, tunes wireless radios 1513 to receive the broadcast packets from eNB 1503. Method 1700 may also involve, at 1740, determining information corresponding to at least one of the eliminated fields. For example, having received USD 1507 with a compression flag, UE 120 knows to execute decompression algorithm 1506d to use the information contained in a description file, such as USD 1507, in memory 382, to retrieve or recover the compressed data.

In an additional aspect, another example compression algorithm may include a combination of both a compression flag in the USD or FDT along with a context ID to provide the compression mapping to the UE.

In a related aspect, determining information corresponding to an eliminated field includes processing a context ID which was included as part of the broadcast data packet. In another aspect the determining may include utilizing information that is known to be static and has been previously provided to the user entity. Such information may be previously provided in any number of ways, e.g. previously provided within a USD message or in an FDT.

In yet another related aspect, determining information corresponding to an eliminated field may include deriving the content of variable fields. Such a derivation may take into account predictable variations which are expected in a particular field and the like.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and process steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or non-transitory wireless technologies, then the coaxial cable, fiber optic cable, twisted pair, DSL, or the non-transitory wireless technologies are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method operable by a network entity for wireless communication, comprising:
forming a compressed broadcast data packet by causing at least one field in a packet header of a broadcast data packet to be excluded, wherein the data of the at least one field is data that is otherwise available to a user entity;
transmitting a notification to the user entity within a description message, the notification indicating that at least one compressed broadcast data packet will be transmitted; and
transmitting the compressed broadcast data packet to the user entity.

2. The method of claim 1, wherein the at least one field includes at least one static field having information that is available to the user entity is known from a USD (User Service Description) message.

3. The method of claim 2, wherein the at least one static field known from the USD message includes at least one of: version, source IP (Internet Protocol) address, destination IP address, protocol, next header, header length, congestion control information, transport session ID, and leading bits in a control flag field.

4. The method of claim 1, further comprising including a context identifier field in the description message.

5. The method of claim 1, further comprising forming the description message to have a compression context which indicates whether the at least one excluded field is a static field.

6. The method of claim 1, further comprising forming the description message to have a compression context which indicates whether the at least one excluded field is a field that is variable and predictable.

7. The method of claim 1 further comprising forming the description message to include compression configuration parameters for use when decompressing the compressed data packet.

8. The method of claim 1 wherein the description message is at least one of: a USD and a FDT (File Delivery Table).

9. The method of claim 1, wherein the data packet is a FLUTE/UDP/IP (File Delivery over Unidirectional Transport/User Datagram Protocol/Internet Protocol) data packet.

10. An apparatus comprising:
means for forming a compressed broadcast data packet by causing at least one field in a packet header of a broadcast data packet to be excluded, wherein the data of the at least one field is data that is otherwise available to an end user entity;
means for transmitting a notification to the user entity within a description message, the notification indicating that at least one compressed broadcast data packet will be transmitted; and
means for transmitting the compressed broadcast data packet to the user entity.

11. The apparatus of claim 10, wherein the at least one field includes at least one static field having information that is available to the user entity is known from a USD message.

12. The apparatus of claim 11, wherein the at least one static field known from the USD message includes at least one of: version, source IP (Internet Protocol) address, destination IP address, protocol, next header, header length, congestion control information, transport session ID, and leading bits in a control flag field.

13. The apparatus of claim 10, further comprising means for including a context identifier field in the compressed broadcast data packet.

14. The apparatus of claim 13, wherein the context identifier field is included in the description message.

15. The apparatus of claim 10, further comprising forming the description message to have a compression context which indicates whether the at least one excluded field is a static field.

16. The apparatus of claim 10, further comprising means for forming the description message to have a compression context which indicates whether the at least one excluded field is a field that is variable and predictable.

17. The apparatus of claim 10 further comprising means for forming the description message to include compression configuration parameters for use when decompressing the compressed data packet.

18. The apparatus of claim 10 wherein the description message is at least one of: a USD and a FDT (File Delivery Table).

19. The apparatus of claim 10, wherein the data packet is a FLUTE/UDP/IP (File Delivery over Unidirectional Transport/User Datagram Protocol/Internet Protocol) data packet.

20. An apparatus comprising:
at least one processor configured to:
form a compressed broadcast data packet by causing at least one field in a packet header of a broadcast data packet to be excluded, wherein the data of said at least one field is data that is otherwise available to an end user entity; and transmit said compressed broadcast data packet to the user entity; and
transmit a notification to the user entity within a description message, the notification indicating that at least one compressed broadcast data packet will be transmitted; and
a memory coupled to the at least one processor for storing the compressed broadcast data packet.

21. The apparatus of claim 20, wherein the at least one field includes at least one static field having information that is available to the user entity is known from a USD (User Service Description) message.

22. The apparatus of claim 21, wherein the at least one static field known from the USD message includes at least one of: version, source IP (Internet Protocol) address, destination IP address, protocol, next header, header length, congestion control information, transport session ID, and leading bits in a control flag field.

23. The apparatus of claim 20, wherein the at least one processor is further configured to include a context identifier field in the compressed broadcast data packet.

24. The apparatus of claim 23, wherein the context identifier field is included in the description message.

25. The apparatus of claim 20, wherein the at least one processor is further configured to form the description message to have a compression context which indicates whether the at least one excluded field is a static field.

26. The apparatus of claim 20, wherein the at least one processor is further configured to form the description message to have a compression context which indicates whether the at least one excluded field is a field that is variable and predictable.

27. The apparatus of claim 20, wherein the at least one processor is further configured to form the description message to include compression configuration parameters for use when decompressing the compressed data packet.

28. The apparatus of claim 20, wherein the description message is at least one of: a USD and a FDT (File Delivery Table).

29. The apparatus of claim 20, wherein the data packet is a FLUTE/UDP/IP (File Delivery over Unidirectional Transport/User Datagram Protocol/Internet Protocol) data packet.

30. A computer program product, comprising:
a non-transitory computer-readable medium comprising code for causing a computer to:
form a compressed broadcast data packet by causing at least one field in a packet header of the compressed broadcast data packet to be excluded, wherein the data of the at least one field is data that is otherwise available to a user entity;
transmit a notification to the user entity within a description message, the notification indicating that at least one compressed broadcast data packet will be transmitted; and
transmit the compressed broadcast data packet to the user entity.

31. The computer program product of claim 30, wherein the code further causes a computer to include a context identifier field in the compressed broadcast data packet.

32. The computer program product of claim 31, wherein the context identifier field is included in the description message.

33. The computer program product of claim 30, wherein the code further causes a computer to form the description message to have a compression context which indicates whether the at least one excluded field is a static field or a field that is variable and predictable.

34. The computer program product of claim 30, wherein the code further causes a computer to form the description message to include compression configuration parameters for use when decompressing the compressed data packet.

35. The computer program product of claim 30 wherein the description message is at least one of: a USD (User Service Description) and a FDT (File Delivery Table).

36. A method operable by a mobile entity for wireless communication, comprising:
receiving a description message which includes a notification indicating that at least one compressed broadcast data packet will be transmitted to the mobile entity;
receiving a compressed broadcast data packet via a wireless network, wherein the compressed broadcast data packet has been compressed prior to transmission in order to eliminate one or more fields from the packet header of the compressed broadcast data packet; and
determining information corresponding to at least one of the eliminated fields.

37. The method of claim 36, wherein the determining comprises processing a context ID which is included as part of the description message.

38. The method of claim 36, wherein the determining comprises utilizing information that is known to be static and has been previously provided to the mobile entity in a USD (User Service Description) message.

39. The method of claim 36, wherein the determining comprises deriving the content of variable fields from data previously provided within a USD message.

40. The method of claim 36, wherein the compressed broadcast data packet is a compressed FLUTE (File Delivery over Unidirectional Transport)/UDP/IP data packet.

41. The method of claim 36, wherein the description message includes compression configuration parameters for use by the mobile entity when decompressing the compressed data packet.

42. The method of claim 36, wherein the description message is at least one of: a USD and a FDT (File Delivery Table).

43. An apparatus comprising:
means for receiving a description message which includes a notification indicating that at least one compressed broadcast data packet will be transmitted to the mobile entity;
means for receiving a compressed broadcast data packet via a wireless network, wherein the compressed broadcast data packet has been compressed prior to transmission in order to eliminate one or more fields from the packet header of the compressed broadcast data packet; and
means for determining information corresponding to at least one of the eliminated fields.

44. The apparatus of claim 43, further comprising:
means for reconstructing the compressed broadcast data packet to be in an uncompressed form.

45. The apparatus of claim 43, wherein the means for determining information for at least one eliminated field includes a means for searching for data which has been indicated in the description message as being previously received and stored by the apparatus.

46. The apparatus of claim 43, further comprising:
means for receiving an indication that the compressed broadcast data packet has been compressed.

47. The apparatus of claim 43, wherein the compressed broadcast data packet is a compressed FLUTE (File Delivery over Unidirectional Transport)/UDP/IP data packet.

48. The apparatus of claim 43, wherein the description message includes compression configuration parameters for use by the mobile entity when decompressing the compressed data packet.

49. The apparatus of claim 43, wherein the description message is at least one of: a USD (User Service Description) and a FDT (File Delivery Table).

50. An apparatus comprising:
at least one processor configured to receive a description message which includes a notification indicating that at least one compressed broadcast data packet will be transmitted to the mobile entity and a compressed broadcast data packet via a wireless network, wherein the compressed broadcast data packet has been compressed prior to transmission in order to eliminate one or more fields from the packet header of the compressed broadcast data packet and configured to determine information corresponding to at least one of the eliminated fields; and
a memory coupled to the at least one processor for storing the compressed broadcast data packet.

51. The apparatus of claim 50, wherein the at least one processor is further configured to reconstruct the compressed broadcast data packet to be in an uncompressed form.

52. The apparatus of claim 50, wherein the at least one processor configured to determine information for at least one eliminated field is further configured to search for data which has been indicated in the description message as being previously received and stored by the apparatus.

53. The apparatus of claim 50, wherein the at least one processor is further configured to utilize data which has been previously received and stored by the apparatus to determine at least one of the eliminated fields.

54. The apparatus of claim 50, wherein the compressed broadcast data packet is a compressed FLUTE (File Delivery over Unidirectional Transport)/UDP/IP data packet.

55. The apparatus of claim 50, wherein the determining comprises processing a context ID which is included as part of the description message.

56. The apparatus of claim 50, wherein the description message includes compression configuration parameters for use by the mobile entity when decompressing the compressed data packet.

57. The apparatus of claim 50, wherein the description message is at least one of: a USD (User Service Description) and a FDT (File Delivery Table).

58. A computer program product, comprising:
a non-transitory computer-readable medium comprising code for causing a computer to:
receive a description message which includes a notification indicating that at least one compressed broadcast data packet will be transmitted to the mobile entity;
receive a compressed broadcast data packet via a wireless network, wherein the compressed broadcast data packet has been compressed prior to transmission in order to eliminate one or more fields from the packet header of the compressed broadcast data packet; and
determine information corresponding to at least one of the eliminated fields.

59. The computer program product of claim 58, wherein the code for causing the computer to determine comprises code for causing a computer to process a context ID which is included in the description message.

60. The computer program product of claim 58, wherein the code for causing the computer to determine comprises code for causing a computer to utilize information that is known to be static and has been previously provided to the mobile entity within a USD message.

61. The apparatus of claim 58, wherein the description message includes compression configuration parameters for use by the mobile entity when decompressing the compressed data packet.

62. The apparatus of claim 58, wherein the description message is at least one of a USD (User Service Description) and a FDT (File Delivery Table).
